(19) United States
(12) Patent Application Publication
(10) Pub. No.: US 2006/0179199 A1
(43) Pub. Date: Aug. 10, 2006

(54) Information handling system featuring reduced amount of time for handling interrupts

(75) Inventors: Jonathan Stern, Round Rock, TX (US); Ricardo L. Martinez, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/051,853

(22) Filed: Feb. 4, 2005

(51) Int. Cl. G06F 13/24

(52) U.S. Cl. 710/268

(57) ABSTRACT

In one embodiment, in response to determining that an information handling system (“IHS”) is in a first state, it is determined whether an interrupt was caused by a source included in a first group of potential sources. Also, in response to determining that the IHS is in a second state, it is determined whether the interrupt was caused in a source included in a second group of potential sources. In another embodiment, in response to determining that an IHS is in a first state, a source of an interrupt request is determined by checking potential sources in response to a first previously determined sequence. Also, in response to determining that the IHS is in a second state, the source of the interrupt request is determined by checking the potential sources in response to a second previously determined sequence.

### BACKGROUND

The description herein relates generally to information handling systems and more particularly to reducing the amount of time for handling interrupts in such systems.

As the value and use of information continues to increase, individuals and businesses seek additional ways to process and store information. One option is an information handling system (“IHS”). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

While an IHS, such as a computer system, is operating, one or more hardware components of the IHS may output (e.g., generate) an interrupt (e.g., a system management interrupt (“SMI”)). In response to a SMI, the IHS determines the SMI's source (e.g., a hardware component that generated the SMI), so that it is capable of handling the SMI.

Determining an SMI's source and handling the SMI disrupts the IHS' conventional operations (e.g., an operation performed by the IHS before the SMI is generated). Such disruption may cause various problems including problems associated with video and audio playbacks.

Accordingly, what is needed is a method and an IHS for reducing the amount of time for handling an interrupt, without the disadvantages discussed above.

### SUMMARY

In one embodiment, in response to determining that an information handling system (“IHS”) is in a first state, it is determined whether an interrupt was caused by a source included in a first group of potential sources. Also, in response to determining that the IHS is in a second state, it is determined whether the interrupt was caused in a source included in a second group of potential sources.

In another embodiment, in response to determining that an IHS is in a first state, a source of an interrupt request is determined by checking potential sources in response to a first previously determined sequence. Also, in response to determining that the IHS is in a second state, the source of the interrupt request is determined by checking the potential sources in response to a second previously determined sequence.

### BRIEF DESCRIPTION OF THE DRAWINGS

FIG. 1 is a block diagram of an information handling system (“IHS”) according to an illustrative embodiment.

FIG. 2 is a flow chart of operations of a process executed by the IHS of FIG. 1 for handling an interrupt, according to an illustrative embodiment.

FIG. 3 is a flow chart of operations of a process executed by the IHS of FIG. 1 for handling an interrupt, according to another embodiment.

FIG. 4 is a flow chart of operations of a process executed by the IHS of FIG. 1 for determining an interrupt's source while the IHS is in one of its states, according to an illustrative embodiment.

FIG. 5 is a flow chart of operations of a process executed by the IHS of FIG. 1 for determining an interrupt's source while the IHS is in another one of its states, according to an illustrative embodiment.

FIG. 6 is a flow chart of operations of a process executed by the IHS of FIG. 1 for installing interrupt handlers for various states of the IHS, according to an illustrative embodiment.

### DETAILED DESCRIPTION

For purposes of this disclosure, an information handling system (“IHS”) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a consumer electronic device, a network server or storage device, a switch router or other network communication device, or any other suitable device and may vary in size, shape, performance, functionality, and price. The IHS may include memory, one or more processing resources such as a central processing unit (“CPU”) or hardware or software control logic. Additional components of the IHS may include one or more storage devices, one or more communications ports for communicating with external devices as well as various input and output (I/O) devices, such as a keyboard, a mouse, and a video display. The IHS may also include one or more buses operable to transmit communications between the various hardware components.

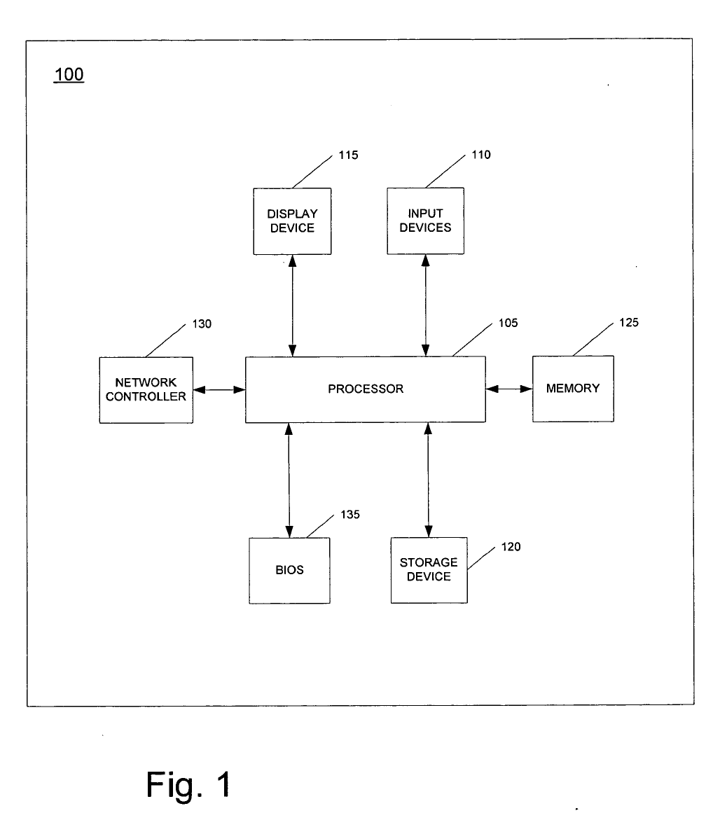

FIG. 1 is a block diagram of an IHS, indicated generally at 100, according to the illustrative embodiment. The IHS 100 includes a processor 105 (e.g., an Intel Pentium series processor) for executing an otherwise processing instructions, input devices 110 for receiving information from a human user, a display device 115 (e.g., a conventional electronic cathode ray tube (“CRT”) device) for displaying information to the user, a storage device 120 (e.g., a non-volatile storage device such as a hard disk drive or other computer readable medium or apparatus) for storing information, a memory device 125 (e.g., random access memory (“RAM”) device and read only memory (“ROM”) device), also for storing information, and a network controller 130 for communicating between the IHS 100 and a network. Each of the input devices 110, the display device 115, the storage device 120, the memory device 125, and the network controller 130 is coupled to the processor 105, and to one another. In one example, the IHS 100 includes various other electronic circuitry for performing other operations of the IHS 100, such as a print device (e.g., a ink-jet printer or a laser printer) for printing visual images on paper.

The input devices 110 includes, for example, a conventional keyboard and a pointing device (e.g., a “mouse”, a roller ball, or a light pen). A user operates the keyboard to input alphanumeric text information to the processor 105, and the processor receives such information from the keyboard. A user also operates the pointing device to input cursor-control information to the processor 105, and the processor 105 receives such cursor-control information from the pointing device.

The IHS 100 also includes a basic input/output system (“BIOS”) 135. The BIOS 135 includes instructions executed by the processor 105, so that the IHS 100 is capable of performing basic operations without executing instructions (e.g., instructions included by an operating system (“OS”) stored by the storage device 120. In one example the BIOS 135 is stored by a ROM (e.g., the memory device 125).

As discussed above, determining a source (e.g., a component of the IHS 100 such as one of the input devices 110 or the network controller 130) of an interrupt (e.g., an SMI) and handling such an interrupt disrupts the IHS 100's conventional operations (e.g., video and audio playback). Accordingly, it is important to reduce the amount of time (e.g., latency) needed to determine an interrupt's source and handle the interrupt.

In one example, the IHS 100 determines an SMI's source by determining whether such SMI was caused (e.g., generated) by a source included in a group of potential sources. Accordingly, the IHS 100 “checks” each potential source included in the group of potential sources to determine the SMI's source. In one version of the example, the group of potential sources is variable for each of the IHS 100's state. For example, the IHS 100 is capable of operating in one of various operating states such as power on self test (“POST”) state, OS state (e.g., a state in which the IHS is executing its OS), and one of reduced power states (e.g., one of the “sleep” or suspended states such as S3, S4, and S5).

For each of the states discussed above, potential sources of an SMI are variable. In one example, while the IHS 100 is in an OS state, a universal serial bus (“USB”) controller is not a potential source of an SMI. However, while the IHS 100 is in a POST state, the USB controller is a potential source of an SMI. Accordingly, in response to determining that it is in a POST state, the IHS 100 determines a SMI's source by determining whether such SMI was generated by a source included in a group of potential sources that includes a USB controller. By comparison, in response to determining that the IHS 100 is in an OS state or any other state where an USB controller is not a potential source for a SMI, the IHS 100 determines a SMI's source by determining whether such SMI was generated by a source included in a group of potential sources that does not include an USB controller. Accordingly, for each of its states, the IHS 100 is capable of handling a SMI by using a group (e.g., a group as represented by a list) of potential sources of the SMI that is associated with (e.g., customized for) the state.

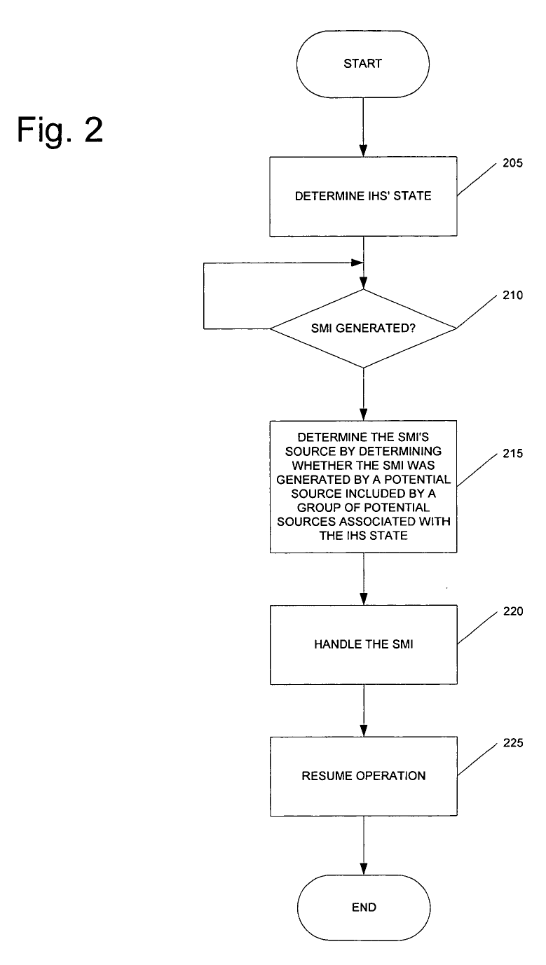

FIG. 2 is a flow chart of operations of a process executed by the IHS 100 for handling a SMI, according to an illustrative embodiment. The operation begins at a step 205, where the IHS 100 determines its state. After the step 205, the operation continues to a step 210.

At the step 210, the IHS 100 self-loops until it has determined that a SMI was generated. In response to determining that a SMI was generated, the operation continues to a step 215.

At the step 215, the IHS 100 determines the SMI's source. As discussed above, the IHS 100 determines the SMI's source by determining whether the SMI was generated by a source included in a group, of potential sources, that is suitable for the state determined at the step 205. After the step 215, the operation continues to a step 220.

At the step 220, the IHS 100 handles the SMI. After the step 220, the operation continues to a step 225 where the IHS 100 resumes its operation (e.g., the operation the IHS 100 was performing before the SMI was generated). After the step 225, the operation ends.

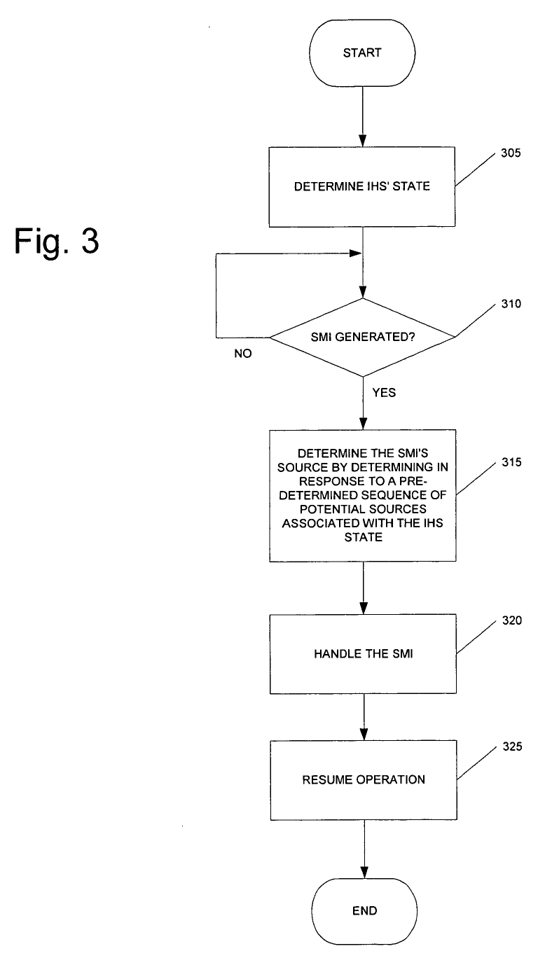

FIG. 3 is a flow chart of operations of a process executed by the IHS 100 for handling a SMI, according to another embodiment. The operation begins at a step 305, where similar to the step 205 of FIG. 2, the IHS 100 determines its state. After the step 305, the operation continues to a step 310.

At the step 310, the IHS 100 self loops until it has determined that a SMI was generated. In response to determining that a SMI was generated, the operation continues to a step 315.

At the step 315, the IHS 100 determines the SMI's source. In this embodiment, the IHS 100 determines such source in response to a pre-determined sequence, of potential sources, that is suitable for the state determined at the step 305. In one example, such sequence is pre-determined according to each of the potential sources' likelihood to be the actual source of a SMI generated while the IHS 100 is in the state determined at the step 305. Accordingly, when sequentially “checking” each of the potential sources to determine whether it is the SMI's source, the IHS 100 generally checks the potential sources with relatively high likelihood of being the actual source of the SMI for a state before the potential sources with relatively low likelihood of being the actual source of the SMI for the state. After the step 315, the operation continues to a step 320.

Similar to the step 220 of the FIG. 2, at the step 320, the IHS 100 handles the SMI. After the step 320, the operation continues to a step 325, where the IHS 100 resumes its operation.

In yet another embodiment, for each of its states, the IHS 100 determines a SMl's source by combining one or more aspects of the embodiments already discussed above. In one example, in response to determining that it is in a first state, the IHS 100 determines a SMl's source in response to a first group of potential sources, sequence of which, is suitable for the first state. In response to determining that it is in a second state, the IHS 100 determines a SMI's source in response to a second group of potential sources, sequence of which, is suitable of the second state.

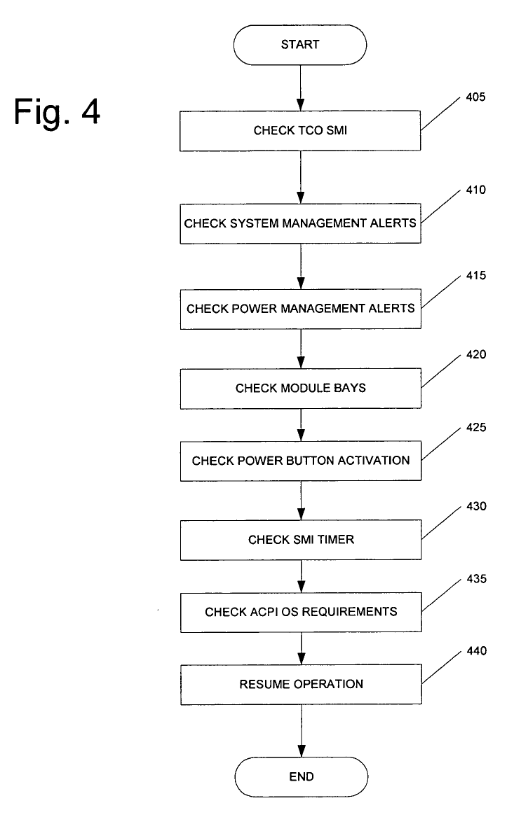

FIG. 4 is a flow chart of operations of a process executed by the IHS 100 for determining a SMI's source while the IHS 100 is in one of its states. More specifically, the IHS 100 performs the operations depicted by FIG. 4 while it is in the OS state. As discussed above, in connection with FIGS. 2 and 3, in response to a SMI, the IHS 100 determines the source of the SMI so that it is capable of handling the SMI. The operation begins at a step 405, where the IHS 100 checks the total cost of ownership (“TCO”) SMI.

After the step 405, the operation continues to steps 410, 415, 420, 425, 430, and 435, where the IHS 100 checks various other potential sources to determine the SMI's actual source and handle the SMI. At steps 410, 415, 420, 425, 430, and 435, the IHS 100 respectively checks system management alerts, power management alerts, module bays, power button activation, SMI timer, and advance configuration and power interface (“ACPI”) OS requirements. After the step 435, the operation continues to a step 440.

At the step 440, the IHS 100 resumes its normal operation. After the step 440, the operation ends as shown.

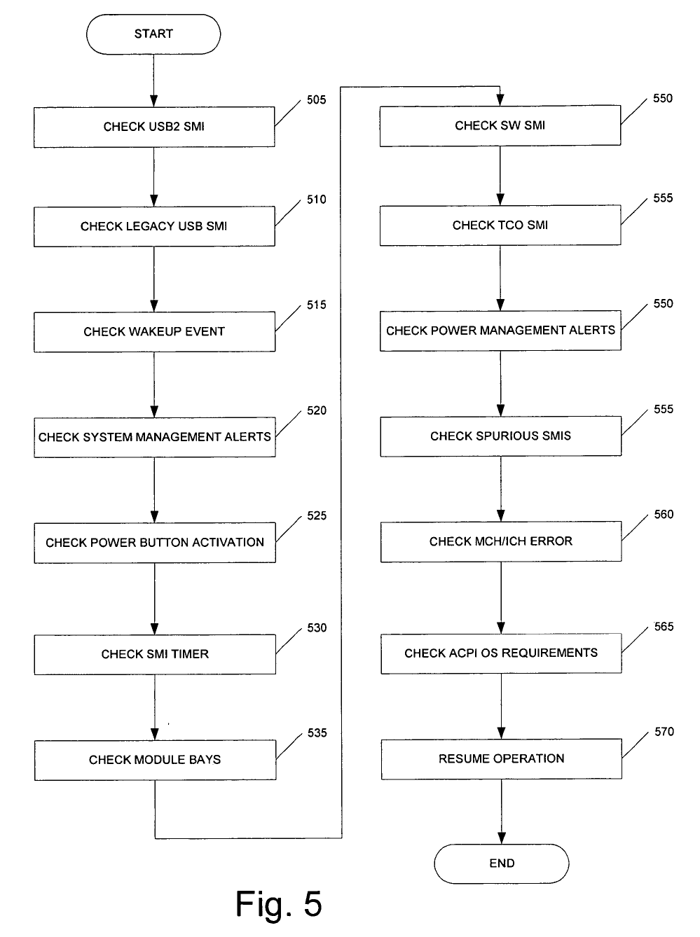

FIG. 5 is a flow chart of operations of another process executed by the IHS 100 for determining a SMI's source while the IHS 100 is in another one of its states. More specifically, the IHS 100 performs the operations depicted in FIG. 5 while it is resuming its operations from a low power state (e.g., “S5” state).

The operation begins at a step 505, where the IHS 100 checks its USB 2. After the step 505, the IHS 100 checks various other potential sources to determine the SMI's actual source and handles the SMI. At steps 510, 515, 520, 525, 530, 535, 540, 545, 550, 560, and 565, the IHS 100 respectively checks legacy USB, resume (e.g., “wake up”) event, system management alerts, power button activation, SMI timer, module bays, software SMI, TCO SMI, power management alerts, spurious SMIs, controller hubs (e.g., memory controller hub (“MCH”) and input/output controller hubs (“ICH”)). After the step 565, the operation continues to a step 570.

At the step 570, the IHS 100 resumes its normal operation. After the step 570, the operation ends as shown in FIG. 5.

The following discussion simultaneously references FIGS. 4 and 5. As discussed above, the IHS 100 determines a SMI's actual source by checking groups of potential sources that are variable in response to the IHS 100's state. For example, while it is resuming from a low power state, the IHS 100 checks legacy USB, USB2, and controller hubs along with other potential sources as shown in FIG. 4. Moreover, as shown in FIG. 4, the IHS 100 does not check such potential sources while it is in the OS state.

Also as discussed above, sequences in which the IHS 100 checks the potential sources are variable in response to the IHS 100's state. For example, while it is in the OS state, the IHS 100 checks the TCO SMI before the system management alerts and power button activation as shown in FIG. 4. By comparison, the IHS 100 checks both the system management alerts and power button activation before checking the TCO SMI as shown in FIG. 5.

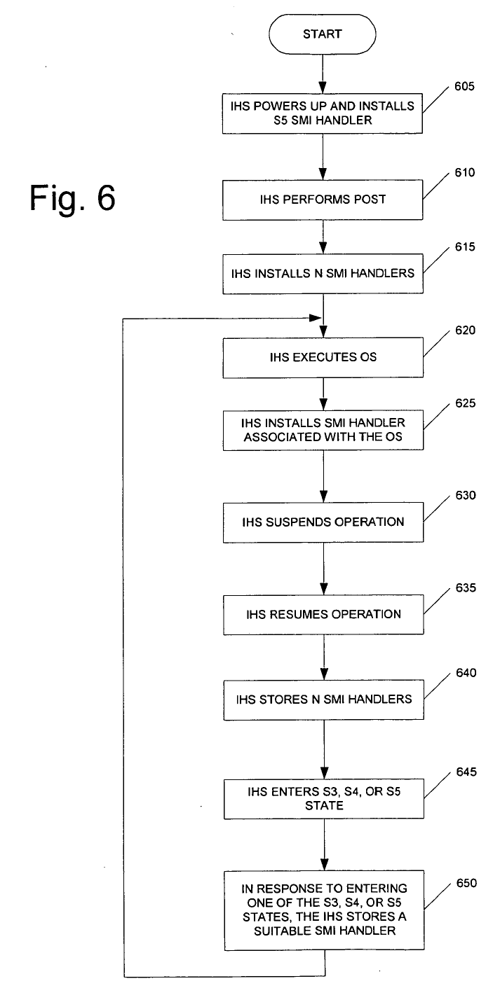

FIG. 6 is a flow chart of operations of a process executed by the IHS 100 for installing SMI handlers for various states of the IHS 100. The operation begins at a step 605 where the IHS powers and installs a SMI handler for a low power state (e.g., “S5” state). After the step 605, the operation continues to a step 610 where the IHS 100 performs the POST. After the step 610, the operation continues to a step 615.

At the step 615, the IHS 100 installs SMI handlers for the IHS 100's various states. In one example, the IHS 100 installs N SMI handlers on its SMBASE storage device (e.g., a register) at addresses determined in response to the following algorithm.
SMBASE+N*M . . . SMBASE+((N−1)*M) while N>=1, where M=size of (SMI handler)

After the step 615, the operation continues to a step 620 where the IHS 100 executes its OS. Accordingly, the OS takes ownership of one or more components (e.g., USB) of the IHS 100. After the step 620, the operation continues to a step 625.

At the step 625, the IHS 100 installs a SMI handler that is associated with (e.g., customized for) the OS. In one example, the IHS 100 installs such SMI handler by re-writing to the SMBASE register. After the step 625, the operation continues to a step 630.

At the step 630, the IHS 100 suspends its operation (e.g., enters a low power state). In the illustrative embodiment, in association with suspending its operation, the IHS 100 executes the SMI handler that was installed at the step 625. After the step 630, the operation continues to a step 635, where the IHS 100 resumes its operation. After the step 635, the operation continues to a step 640.

At the step 640, the IHS 100 stores various SMI handlers on the IHS 100's SMBASE register. The IHS 100 stores such handlers according to an algorithm that is substantially similar to the algorithm discussed in the step 615. After the step 640, the operation continues to a step 645.

At the step 645, the IHS 100 enters a low power state (e.g., one of “S3”, “S4”, or “S5” states). After the step 645, the operation continues to a step 650, where in response to detecting the low power state, the IHS 100 installs a SMI handler that is suitable for handling a SMI while in the low power state that is detected. After the step 650, the operation returns to the step 620 as shown.

In one embodiment, one of the SMI handlers discussed above includes two or more distinct SMI handlers that are installed in response to IHS 100's transition from one state to another state. In another embodiment, such SMI handler includes one or more tables and priority tags.

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. A method comprising:
in response to determining that an information handling system (“IHS”) is in a first state, determining whether an interrupt was caused by a source included in a first group of potential sources; and
in response to determining that the IHS is in a second state, determining whether the interrupt was caused by a source included in a second group of potential sources.

2. The method of claim 1, wherein the first group includes a potential source that is not included in the second group.

3. The method of claim 1, wherein the second group includes a potential source that is not included in the first group.

4. The method of claim 1, wherein the interrupt is a system management interrupt (“SMI”).

5. The method of claim 1, wherein the first group includes universal serial bus (“USB”).

6. The method of claim 1, wherein the second group includes USB.

7. A method comprising:
in response to determining that an information handling system (“IHS”) is in a first state, determining a source of an interrupt request by checking potential sources in response to a first previously determined sequence; and
in response to determining that the IHS is in a second state, determining the source of the interrupt request by checking the potential sources in response to a second previously determined sequence.

8. The method of claim 7, wherein the first sequence is previously determined in response to each of the potential sources' likelihood of being an actual source of the interrupt while the IHS in the first state.

9. The method of claim 7, wherein the second sequence is previously determined in response to each of the potential sources' likelihood of being an actual source of the interrupt while the IHS in the second state.

10. The method of claim 7, wherein the potential sources include the IHS' components.

11. The method of claim 10, wherein the components included USB.

12. An information handling system comprising:
a processor; and
a memory, coupled to the processor, that stores instructions when executed by the processor causes the IHS to:
in response to determining that the IHS is in a first state, determine whether an interrupt was caused by a source included by a first group of potential sources; and
in response to determining that the IHS is in a second state, determine whether the interrupt was caused by a source included by a second group of potential sources.

13. The system of claim 12, wherein the first group includes a potential source that is not included in the second group.

14. The system of claim 12, wherein the second group includes a potential source that is not included in the first group.

15. The system of claim 12, wherein the interrupt is a system management interrupt (“SMI”).

16. The system of claim 12, wherein the first group includes universal serial bus (“USB”),

17. The system of claim 12, wherein the second group includes USB.

18. The system of claim 12, wherein the instructions are included in a basic input output system (“BIOS”).

19. An information handling system comprising:
a processor; and
a memory, coupled to the processor, that stores instruction when executed by the processor causes the IHS to:
in response to determining that the IHS is in a first state, determine a source of an interrupt request by checking potential sources in response to a first previously determined sequence; and
in response to determining that the IHS is in a second state, determine the source of the interrupt request by checking the potential sources in response to a second previously determined sequence.

20. The system of claim 19, wherein the first sequence is previously determined in response to each of the potential sources' likelihood of being an actual source of the interrupt while the IHS in the first state.

21. The system of claim 19, wherein the second sequence is previously determined in response to each of the potential sources' likelihood of being an actual source of the interrupt while the IHS in the second state.

22. The system of claim 19, wherein the potential sources include the IHS' components.

23. The system of claim 22, wherein the components include USB.

24. The system of claim 19, wherein the instructions are included in a basic input output system (“BIOS”).
